(19) United States
(12) Patent Application Publication
(10) Pub. No.: US 2010/0064681 A1
(43) Pub. Date: Mar. 18, 2010

(54) Method for increasing performance of a stirling or free-piston engine

(75) Inventor: Mark Edward Yegge, Belleair Beach, FL (US)

Correspondence Address: Mark E. Yegge, 3121 Tiffany Drive, Belleair Beach, FL, 33786, US

(73) Assignee: NextWave Solar, Inc., Belleair Bluffs, FL (US)

(21) Appl. No.: 12/284,012

(22) Filed: Sep. 18, 2008

(51) Int. Cl. F02G 1/05

(52) U.S. Cl. 60/520; 60/522

(57) ABSTRACT

A method for improving performance of a free-piston engine, also comprising various other engines such as Stirling Engines, Ericsson engines, Stirling cryocoolers and other external combustion or hot air engines. The improvement is the inclusion of a means, such as a valve or set of valves interposed in a passageway, to contain the working fluid (gas) in the hot or expansion work area so that increased work can occur; or the improvement is by means of piston blocking a port to the working gas passageway such that working gas is contained in the work space such that increased work can occur. The improvement reduces or ideally eliminates free flow of fluid until such time in the cycle where valve or port opens and allows the fluid to flow to the passageway from one space to the other.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLE, OR A COMPUTER PROGRAM LISTING COMPACT DISK APPENDIX

Not Applicable

### BACKGROUND OF THE INVENTION

1. Field of the Invention

This invention relates generally to improving the performance of a free-piston or Stirling engine. Stirling engines and similar motors are distinguished as motors operated by expansion and/or contraction of a unit of mass of motivating medium. The unit of mass is a gas which is heated or cooled in one of a plurality of constantly communicating expansible chambers and freely transferable therebetween. The present invention more specifically relates to having means to control rate of flow of mass between chambers.

2. Technical Background

Thermal differences may be used to power an engine to provide the thermal dynamic sources producing mechanical and electrical power through an alternator. The thermal dynamic engines include various thermal dynamic cycles which are harnessed to provide the mechanical energy for various engines. Various cycles include Stirling cycles, Brayton cycles, and Rankine cycles. These various cycles can be employed in engines using the same or similar name as the engine. Generally, each of these engines provide for producing energy from one of the related thermal dynamic cycles. The thermal dynamic cycles and the related engines require a differential in thermal energy to create the mechanical and electrical energy from the engine.

The increased economic feasibility of utilizing energy from solar energy collector concentrators and the like, as well as the burning of inexpensive waste products has increased the attractiveness of the free piston Stirling engine as a machine for directly converting heat energy to mechanical energy. Also, Stirling cycle heat pumps are effective machines for pumping heat from a cold mass to a warm mass and for utilization in refrigeration and heating systems. The Stirling cycle engine has been known for decades and relies upon the pressure variations of a mass of working fluid confined in a work space. The pressure variations are caused by the alternate heating and cooling of the working fluid which is forced by a displacer piston between communicating hot space and cold space portions of the work space as described by Beale in U.S. Pat. Nos. 3,645,649 and 3,828,558, as well as French Pat. Nos. 1,407,682 and 1,534,734.

The improvement of the present invention relates to a method for restricting the working fluid to the work chamber of a free-piston machine, such as a Stirling engine or heat pump, or a kinematic Stirling cycle machine, and allowing it to flow only once a displacer piston reaches the desired point in its cycle or once a certain pressure is achieved. This restriction allows the working fluid to build up more expansion force than is common in free-piston engines, and understood by those skilled in the art, moving a displacer piston outward towards a power piston and creating work. The working fluid is then cooled and returned through the apparatus of the present invention through a valve back into the work area, moving the fluid back to the beginning of the cycle. The apparatus prevents venting of the fluid in a free flowing manner as is common in the art, having the effect of holding the fluid in the work area longer.

The term valve is not restricted herein specifically to valves, but to describe any flow restricting mechanism such as a check valve, gate valve, diaphragm valve, swing valve, flow limiter, et cetera. The term passageway as referred to herein is not limited to a passageway as described or illustrated in the drawings, but any method whereby the working fluid may pass or be restricted as is understood by those skilled in the art. There are many passageway methods utilized in Stirling cycle engines and the present invention is intended to describe any passageway that may be used to transfer the working fluid from the hot space to the cold space, or from the cold space to the hot space as is commonly found in Stirling engines or Stirling coolers, cryocoolers, refrigerators or heat pumps. The term piston as referred to herein is not limited to cylindrical devices, but any reciprocating method used to derive power or displacement from expansion, contraction, compression or evacuation within a closed chamber such as a diaphragm or bellows.

3. Background

A conventional Stirling engine has a reversible cycle which includes two isothermal changes and two equivalent changes. Namely, the Stirling engine has a cycle which cold (isothermally) compresses an operational gas such as helium enclosed therein with external cooling. Further, the heat efficiency is high, hazards to the public minimal and it is able to use the variety fuels, including solar energy, natural gas and others. As a result, the Stirling engine is suitable as a power source of a compressor for an air-conditioning and heating device and can be used as an electricity generator.

Free piston Stirling machines and often non free piston Stirling machines typically comprise the components of a cylindrical housing containing a reciprocating power piston and a reciprocating displacer. A free-piston Stirling cycle device is described in U.S. Pat. No. 3,522,120, issued to Beale. The piston divides the interior of the housing into two gas spaces. One space is a work space bounded by the piston on the displacer side of the piston, and the other is a back space or bounce space bounded by the other side of the piston. Heat is supplied to the gas or working fluid in the work space and together with the piston and displacer cooperates to cyclically compress and expand the gas therein to convert a portion of the supplied heat into work. The work space is divided by the piston into the cold space and the hot space, although the cycle may be reversed in other machines known in the art such as refrigerators and heat pumps. The working gas flows freely through a passageway from the hot space to the cold space and often through a regenerator. The gas in the back space may act as a spring to limit the motion of the piston during the power stroke of the engine and to sustain the reciprocation of the piston and displacer in timed, although out of phase, relation. Heat is removed from the gas in the work space in an amount equal to the difference in the heat supplied and the work produced as required by the first and second laws of thermodynamics. A regenerator device is employed for regenerating some of the heat supplied from one cycle to the next. The working gas or fluid in the engine may be air, hydrogen, helium, other gases, vapors or liquids, or the like.

In a free piston Stirling engine, the power piston may be coupled to magnets which are reciprocated by the piston within alternator windings for converting the mechanical work produced by the engine into electrical energy. A principal advantage of this mode of operation is that the engine requires no external mechanical linkages with other equipment and, therefore, the entire engine may be hermetically sealed. This increases reliability and the lifetime of the engine. In kinematic or traditional Stirling engines, the power piston and displacer piston are linked to a crankshaft.

While reference is made to a Stirling engine, the invention is equally applicable to other Stirling machines such as heat pumps and refrigerators and to other free piston machines such as a free piston compressor or Stirling cycle pump. In such Stirling applications, the direction of the heat and work energy interactions are reversed. The term Stirling machine is intended to refer to Stirling engines, heat pumps, and refrigerators.

Sealing means are provided between the power piston and the inner wall of the housing for substantially sealing the work space from the back space. The sealing means may be in the form of rings or simply a precision fit. In typical Stirling engines, the working fluid is free to flow back and forth between the hot space and the cold space from high pressure to low pressure as the laws of thermodynamics allow, typically moving from an area of high pressure to an area of low pressure. Typically, the working fluid in the hot space becomes heated and begins to vent freely to the cold space where it is cooled by a heat sink mechanism or cooling means and is allowed to flow back to the hot space where the cycle starts again. To a lesser degree and depending on the size of the gap between the piston and the housing, a small amount of fluid flows from high pressure to low pressure between the hot and cold spaces and can often act as a gas bearing mechanism between the piston and the housing. This fluid can flow back and forth between the hot space and the cold space and becomes part of the mixture of the working fluid cycle. The leaky flow of the working fluid through this gap imposes a penalty on the performance of the cycle as the fluid is otherwise not utilized by the cycle to produce work.

The practical problems presented by the existing art is that the relatively free flow of the working gas from the heated space to the cooled space prevents a pressure buildup that could otherwise occur if the gas were held in the heat space relatively longer. As the heat in a relatively closed chamber increases, thermodynamic laws act on the gas having the effect of increasing the heat and the pressure in that chamber. Since in most existing applications, a displacer piston moves freely within the heat space, an increase in pressure would translate to an increase in work performed and hence an increase in performance according to Charles' Law.

Attempts to regulate working fluid flow have been attempted in the art. In U.S. Pat. No. 4,327,550, the working fluid is kept essentially at a high and relatively constant level during a variable interval of the period of increasing primary chamber volume. This has the penalty of releasing working fluid in order to maintain relatively constant pressure thereby reducing power output. In U.S. Pat. No. 4,622,813 the apparatus must use at least two separate heat exchanger assemblies. The problem as it relates to producing higher efficiency is that only one side of the apparatus may be used in any one part of the cycle causing a loss of utilization from the additional regenerator apparatus.

The pressure in the work space undergoes large amplitude changes over the cycle. The hot space pressure, when viewed as a function of time, appears as a pressure wave having a series of peaks which rise rapidly above the cold space pressure. Prohibiting or reducing the flow of gas during a substantial portion of the outward stroke improves power output since there is no substantial gas transfer from the hot work space to the cold work space as would otherwise occur, allowing more thermodynamic forces to act on the cylinder before the working gas leaves the hot work space.

Therefore, in summary, in a typical Stirling cycle machine, the working fluid is allowed to flow freely between the hot space and the cold space effectively causing the fluid to leak prematurely to the cold space. However, a power loss penalty accrues from the fact that working fluid flows out of the hot space without pressurizing more completely in the hot space than it would if it were not allowed to vent until a later time in the cycle.

The improvement of the present invention restricts, reduces or eliminates the flow of the working fluid from the hot space until later in the cycle after it has had a chance to heat more substantially than would otherwise occur, thereby improving performance.

### BRIEF SUMMARY OF INVENTION

The present invention advantageously fills the aforementioned deficiencies by providing a method of improving the performance of a free-piston or Stirling engine.

In order to maximize forces created in the hot space, the working fluid is contained in the hot space of the work space for a longer period of time than typical in Stirling cycle machines until it is allowed to flow, preferably via a passageway, to the cold space of the work space. Various passageways have been employed in the art and the present invention has applicability to all known methods of porting via a passageway, or set of passageways, working fluid from the hot space to the cold space or from the cold space to the hot space. In the preferred embodiment of the present invention, the passageway would be comprised of an uppermost displacer port, or entry port, and a bottom displacer port, or exhaust port. The entry port would have a one way check valve or other restrictive apparatus that serves to block flow of working fluid from the hot space. This reduces the relatively free flow of the working fluid and contains it in the hot space. In the preferred embodiment of the present invention, the exhaust port can be preferably positioned in the lower segment of the outward stroke of the displacer piston. This solves the problem of premature release of the working fluid from the hot working space as the relatively sealed exhaust port serves as a closed valve, halting release into the passageway. Therefore, for purposes of the heating or expansion portion of the cycle, the entry port is an open port only when the piston begins to pass by it on the outward portion of its stroke effectively remaining an open and free flowing port in the desired outward direction away from the hot space until it is again closed by the piston moving past it on the inward portion of its stroke. This is an improvement in that the combination of the closed entry port and the closed exhaust port during the heating portion of the cycle has the effect of keeping the working fluid in the hot space for a longer period allowing it to heat and thus expand more and with more force than if it were allowed to flow freely into the passageway.

Upon the return of the working fluid from the cold space to the hot space, the exhaust port is blocked by means of a one way valve contained in close proximity to the exhaust port. The one-way valve in the closed position serves to block entry into the displacer piston thus allowing the fluid to move from the cold space in this part of the cycle, to the hot space which has been recently relatively evacuated. The working fluid enters the hot space through the entry port passing through a one way valve, mounted in close proximity to the entry port, which now opens to allow the working fluid to flow through the valve and into the hot space via the entry port. In properly timed machines, the entry of the working fluid, the subsequent closing of the one way valve and the near end of the inward displacer piston stroke can have the effect of creating a gas spring at the innermost portion of the displacer piston stroke, which is an improvement in the forces that cause the reversal motion at the end of the piston stroke at the beginning of each cycle. Once this occurs, this cycle ends and a new cycle can begin.

The valve in the exhaust port effectively blocks working fluid from entering into the work area through its orifice. This improvement has the further benefit of preventing a side force on the displacer piston that might otherwise be present if the port were constructed without a one way valve. Side forces are generally seen by those skilled in the art as having a detrimental effect on performance and durability of the machine.

The cycle of an engine according to the present invention differs from the traditional Stirling cycle in that much higher compression ratios are possible. Since the volume of working fluid is kept in the hot space and locked there until the port or valve release it into the passageway, the ratio of the swept volume of the cylinder to the volume of the hot space can determine the compression ratio.

The present invention is made up of the following required elements: a passageway in which the working gas flows between the hot work space and the cold work space; and a flow control mechanism for containing gas in the hot space and subsequently allowing it to release as desired. These elements are related as follows: the flow control mechanism having control of the release of the flow of the working gas between the hot work space and the cold work space.

Further, this invention can also have one or more of the following elements: 1) a port that is closed until a desired position of a piston moves in such manner as to open it by effectively unblocking it by its movement; 2) a mechanism that operates a flow control mechanism in the passageway. Each of these elements relates to the present invention by having control of the release of the flow of the working gas between the hot work space and the cold work space. It should be noted that it is the intention of the present invention that any materials or means to accomplish a containment of the working fluid in the work space such that thermodynamic forces serve to act on the working fluid more efficiently are covered by this application.

One principal objective and improvement of the present invention is to have a reliable, low cost method of increasing power from the machine, without having to increase the size of the machine.

It is another objective of the present invention to enable Stirling machines to operate on lower input temperatures or lower temperature differentials.

It is another object of the present invention to provide improved high power, high speed, modified Stirling cycle engines.

Still further, it is another objective to utilize flow control mechanisms to control the flow of the working fluid into and out of the working space of an engine such that the engine can be controlled more easily.

Finally, it is an object of the present invention to provide an improvement that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set for the herein, rather, these embodiments are provided by way of illustration only and so that this disclosure will be thorough, complete and will fully convey the full scope of the invention to those skilled in the art.

### BRIEF DESCRIPTION OF THE SEVERAL VIEWS OF THE DRAWING

FIG. 1 is a diagrammatic sectional view of a free piston Stirling engine provided with the valve system of the present invention as depicted at the beginning of the Stirling cycle, when the working fluid is beginning to be heated.

FIG. 2 is a diagrammatic sectional view of a free piston Stirling engine provided with the valve system of the present invention as depicted during the part of the Stirling cycle whereby the working fluid has become heated and begins to vent from the hot working space to the cold working space via a passageway.

FIG. 3 is a diagrammatic expanded sectional view of FIG. 1 of the passageway as depicted at the beginning of the Stirling cycle, when the working fluid is beginning to be heated.

FIG. 4 is a diagrammatic expanded sectional view of FIG. 2 of the passageway as depicted during the part of the Stirling cycle whereby the working fluid has become heated and begins to vent from the hot working space to the cold working space via a passageway.

FIG. 5 is a diagrammatic sectional view of a free piston Stirling engine provided with the valve system of the present invention as depicted at the part of the Stirling cycle, when the working fluid has been cooled and is flowing back through the passageway toward the hot space to begin the cycle.

FIG. 6 is a diagrammatic expanded sectional view of FIG. 5 of the passageway as depicted during the part of the Stirling cycle whereby the working fluid has become cooled and begins to vent from the cold working space to the hot working space via a passageway.

FIG. 7 is a diagrammatic sectional view of an alternative configuration of the passageway and alternative mechanical means of opening a controllable valve during the beginning or heating portion of the Stirling cycle.

FIG. 8 is a diagrammatic sectional view of an alternative configuration of the passageway and mechanical means of opening a controllable valve during the cooling portion of the Stirling cycle when the working fluid is returning to the hot space.

FIG. 9 is a diagrammatic sectional view of another alternative configuration of the passageway and means of opening a controllable valve during the Stirling cycle.

FIG. 10 is a sectional view of a kinematic Stirling engine using another alternative configuration of the passageway and means of opening a controllable valve during the Stirling cycle.

### DETAILED DESCRIPTION OF THE INVENTION

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected or terms similar thereto are often used. They are not limited to direct connection but include connection through other elements where such connection is recognized as being equivalent by those skilled in the art. For example, a check valve or similar term thereto is often used. The term is not limited to a certain type of check valve but rather includes means to allow flow in one direction while preventing flow in another direction where such a means is recognized as being equivalent by those skilled in the art.

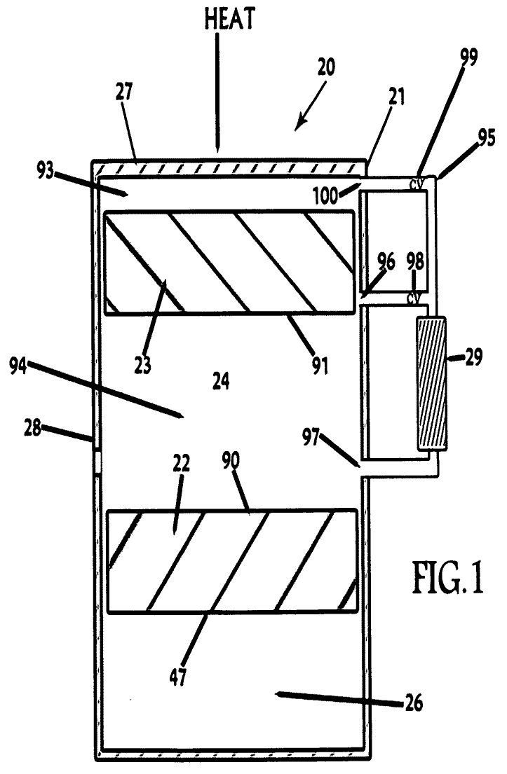

Referring to FIG. 1, free piston Stirling engine 20 comprises housing 21, reciprocating power piston 22, and reciprocating displacer 23. Piston 22 bounds the work space 24 and in combination with the interior of housing 21 defines work space 24 on the displacer side of the piston. Work space 24 is comprised of hot space 93 and cold space 94. The opposite end of the piston similarly bounds the back space 26. The work space and back space contain the same working gas which may be air, hydrogen, helium or other fluids. For driving the engine, heat is supplied to the hot end 27 of the work space and removed from the cool end 28. The flow of heat combined with the reciprocation of the displacer induces the gas in the work space to alternatingly expand and contract whereby piston 22 and displacer 23 reciprocate in housing 21 for producing mechanical work according to well known thermodynamic principles of the prior art (See Beale U.S. Pat. No. 5,461,859). As is also well known in the art, Stirling engine 20 is provided with a regenerator 29 which acts to regenerate heat in the engine from one cycle to the next. The motion of power piston 22 towards work space 24 is referred to as inward motion, while piston motion toward back space 26 is referred to as outward motion. In a mode of the existing art, piston 22 is mechanically coupled to a magnet (not shown) which is reciprocated in an electrical alternator apparatus for converting the mechanical work produced by the piston into electrical energy for any number of uses. Alternatively, the power piston 22 may be coupled to or integrated with any number of devices which may be used to produce work or energy, such as alternators, generators, or hydraulic pumps.

The working fluid moves between hot space 93 and cold space 94 primarily via a passageway 95, which may take many forms as known in the art. The working fluid is heated in the hot space 93 and then expands exerting outward pressure on displacer piston 23. Displacer piston 23 moves outwardly having the effect of moving the power piston 22 outwardly. Upon moving more outward than exhaust port 96 in passageway 95, the working fluid begins to flow through the passageway 95 through exhaust check valve (CV) 98, through the regenerator 29 and exiting the passageway 95 through cold transfer port 97 into the cold space 94. Once a substantial amount of pressure has been relieved in the hot space 93 and upon movement through one way check valve 98, called the exhaust valve, exhaust valve 98 reverts to its normally closed position. During this part of the Stirling cycle, one way check valve 99, called the entry valve remains closed to the expanding gas further allowing heat and pressure to build in hot space 93.

The working fluid is cooled in the cold space 94 once the working fluid enters passageway 95 through cold transfer port 97. The power piston 22, returning in an inward fashion from increased pressure in the bounce space 26, causes the working fluid to return through passageway 95. In doing so, the working fluid travels through regenerator 29 and passes by the closed exhaust port 98 and enters upper part of passageway 95 through entry valve 99 into the hot space 93 via entry port 100 whereby the aforementioned cycle ends and another cycle begins as entry valve 99 closes. In the preferred embodiment of the present invention, when displacer piston 23 is at the beginning of the Stirling cycle and near the inward portion of its movement, one way check valve 99 is closed to the working fluid. Similarly when the working fluid is returning outwardly to the hot space 93 through passageway 95, one way check valve 98 is closed and serves to prevent the working fluid from exerting pressure on displacer piston 23.

During operation, the gas in back space 26 exerts a pressure on the outward surface 47 of piston 22 whereby the gas acts as a spring for sustaining the reciprocating motion of the piston and displacer in timed relation. Similarly, the inward motion of the gas exerts a pressure on the inward surface 90 of piston 22, compressing it within the workspace and exerting a pressure on the outward surface 91 of displacer piston 23 thereby assisting it to move inward.

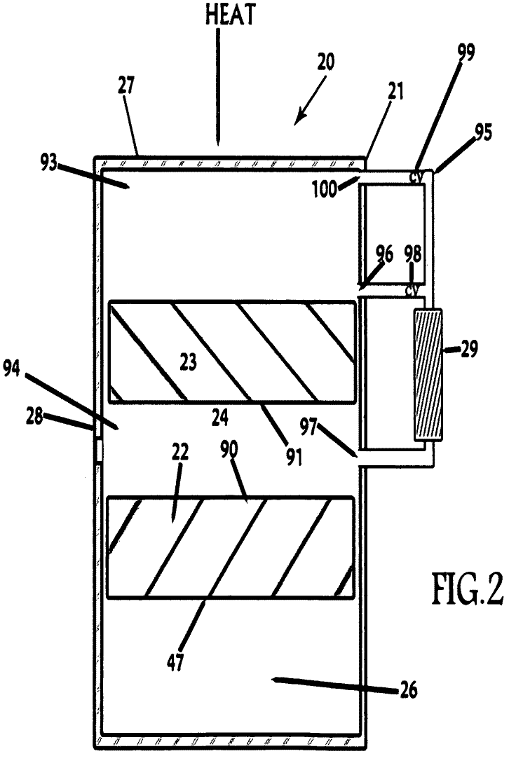

FIG. 2 illustrates graphically the above outward cycle after the displacer piston 23 has outwardly passed exhaust port 96 via valve 98 having the effect of opening it and allowing the working fluid in the hot space to vent through the passageway 95 into cold space 94. The working fluid passes through check valve 98, which opens easily to working fluid flow away from exhaust port 96 but is closed to working fluid passage toward exhaust port 96.

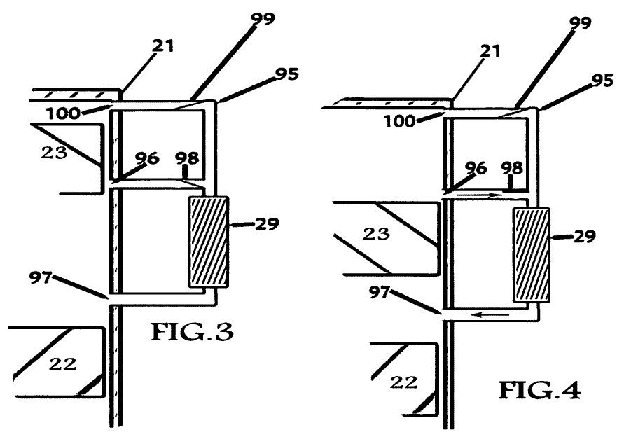

FIG. 3 illustrates graphically an expanded view of the passageway 95 with check valve 98 and check valve 99 each in the closed position. The indicators for check valve 98 and check valve 99, labeled CV in FIG. 1, FIG. 2, and FIG. 5, have been replaced with simple diagrammatic indicators each showing closed positions in FIG. 3. Check valve 99 is in a normally closed position caused by some means of tension inherent in the desired construction of the check valve, thus maintaining its closed position and preventing the working fluid from entering through entry port 100 into the passageway 95. To illustrate operation, check valve 99 is angled in such a way that shows that it is closed to pressure from the hot space through entry port 100. Check valve 98 is in its normally closed position caused by some degree of tension inherent in the desired construction of the check valve. The orientation of check valve 98 is such that it will open to allow flow away from the hot space once displacer piston 23 moves outwardly and unblocks exhaust port 97.

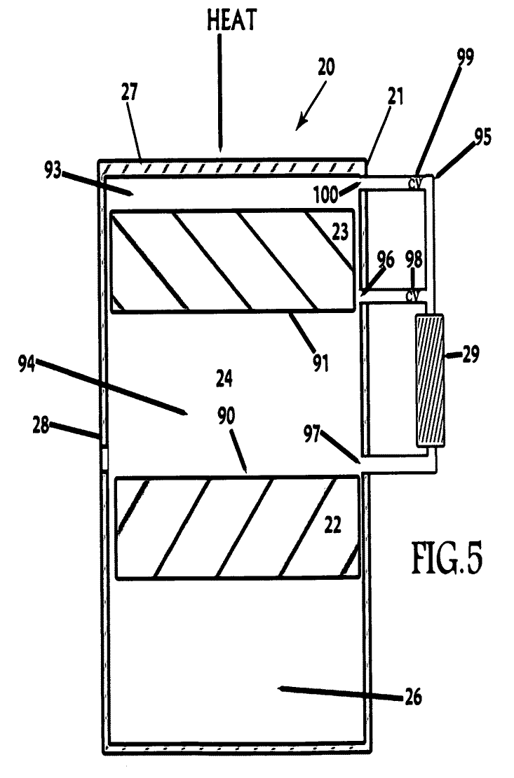

FIG. 4. illustrates graphically an expanded view of the passageway 95 with check valve 99 in the normally closed position as previously described and check valve 98 in the open position as the displacer piston 23 has moved past exhaust port 95. The indicators for check valve 98 and check valve 99, labeled CV in FIG. 1, FIG. 2, and FIG. 5 have been replaced with simple diagrammatic indicators to depict open or closed positions of check valve 98 and check valve 99. Check valve 99 is in a normally closed position caused by some means of tension inherent in the desired construction of the check valve, thus maintaining its closed position and preventing the working fluid from entering through entry port 100 into the passageway 95. As the working fluid flows from the hot space through port 96 into passageway 95, check valve 98 which is normally closed, opens to allow the working fluid to flow from the hot space via exhaust port 96 into passageway 95 in the direction of the arrows as depicted with the working fluid eventually travelling through cold port 97 into the cold space.

FIG. 5 illustrates graphically the part of the Stirling cycle when the working fluid has already been sent to the cold space 94, has been cooled, and can return to the hot space 93 via passageway 95. In this part of the cycle, the power piston 22 has moved inwardly as the working fluid has created a gas spring in bounce area 26 moving power piston inwardly as a result of the spring action by the gas spring effect or similar effect of other types of spring mechanisms as are well known in the art. In similar fashion, as the working fluid has exerted force upon the displacer piston 23 on surface 91, the displacer piston 23 has also nearly completed its travel from the inward area near the cold space 94 outwardly towards hot space 93. As displacer piston 23 moves outwardly, it effectively blocks exhaust port 96 to the working fluid in passageway 95 allowing the working fluid to continue towards one way check valve 99 eventually entering hot space 93 through entry port 100. During this portion of the cycle one way check valve 98 remains closed to the working fluid which may have tended to return to the exhaust port 96. The closure of check valve 98 also assists in preventing loading of forces onto displacer piston 23 relatively improving performance and durability of the engine.

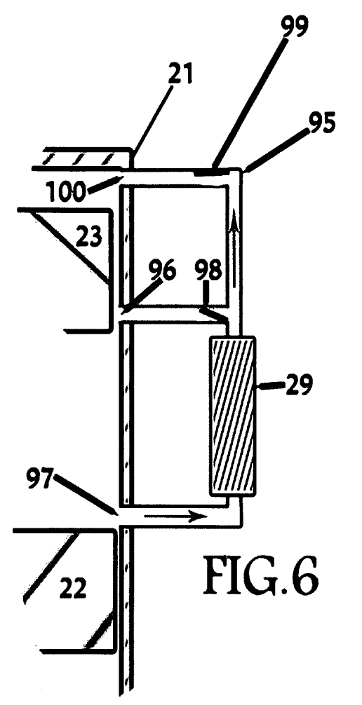

FIG. 6 illustrates graphically the expanded view of passageway 95 during the portion of the Stirling cycle when the working fluid is flowing back to hot work space 93. The CV labels for one way check valves 98 and 99 have been replaced with graphic representations of one way check valves indicating their action assisting the working fluid direction of flow. Many alternative types of valves may be used to allow flow in one direction while restricting flow in another. During this part of the cycle, the working fluid moves from the cold space 94 through port 97 through regenerator 29 in the direction of the arrows as depicted. One way check valve 98 acts in a closed capacity to the working fluid allowing it to continue through one way check valve 99 that opens to allow the gas to continue through port 100 into hot space 93.

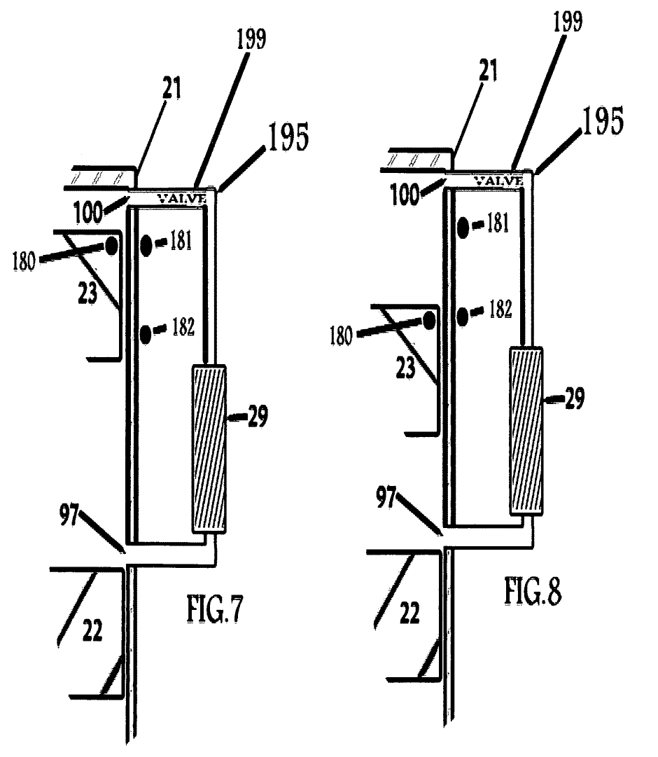

FIG. 7 is a diagrammatic sectional view of the passageway 195 showing an alternate configuration of the present invention including the passageway 195 containing a controllable VALVE 199. FIG. 7 shows the displacer piston 23 at the inward portion of its stroke at the beginning of the Stirling cycle. Controllable, normally closed valve 199 is placed in the outward segment of the passageway 195, outward of regenerator 29. Controllable valve 199 may be opened or closed by a mechanically actuating mechanism utilizing, in this embodiment, sensors or switches to open and close the controllable valve 199. Sensor 180, which may contain magnetically conducting material, may be placed on the displacer piston 23. When controllable valve is in its normally closed position, the working fluid remains in the hot space relatively longer than in a free-flowing configuration commonly found in the art, creating relatively higher expansive forces acting on the surface of displacer piston 23 and moving it outward.

In a variation of the preferred alternative embodiment of the present invention, a configuration of sensor 180 and sensor 181, illustrated in FIG. 7, may act to close valve 199 as displacer piston moves outwardly and after substantial volume of the working fluid has passed controllable valve 199 into the hot space via port 100. After controllable valve 199 remains open to allow the return of the working fluid from the cold space through itself into the hot space, and upon displacer piston 23 moving outwardly such that sensor 180 and sensor 181 are in close proximity, the magnetic force of sensors 180 and 181 work together to actuate a closure of controllable valve 199. Once valve 199 is closed it acts to prevent the working fluid from reentering passageway 195 until it is opened in the next cycle as described above. The valve is alternatingly closed and opened at the appropriate times in the cycle as required to maintain improved performance relative to the current art. An additional benefit of the mechanical or electromechanical means of opening and closing of controllable valve 199 is the ability to control the temporal number of cycles. The performance penalty of opening and closing valve 199 is outweighed by the benefit of increased inward force on displacer piston 23 due to the working fluid remaining in the hot space for increased time.

FIG. 8 is a diagrammatic sectional view of the passageway 195 showing an alternate configuration of the present invention including the passageway 195 containing a controllable valve 199. FIG. 8 illustrates the displacer piston 23 that has moved outwardly in its stroke near the temporal middle of the heating portion of the Stirling cycle. Controllable, valve 199 is placed in the outward segment of the passageway 195, outward of regenerator 29. Controllable valve 199 may be opened or closed by a mechanically actuating mechanism utilizing, in this embodiment, sensors or switches to open and close the controllable valve 199. Sensor 180, which may contain magnetically conducting material may be placed on the displacer piston 23 in order to actuate controllable valve 199. When controllable valve 199 is in a closed position the working fluid remains in the hot space relatively longer than in a free-flowing configuration commonly found in the art, creating relatively higher expansive forces acting on the surface of displacer piston 23 and moving it outward.

An opposing sensor 182 may contain magnetically conducting material. When sensor 180 moves outwardly and in proximity to sensor 182 as depicted in FIG. 8, Sensors 180 and 182 work together to send an electrical or mechanical signal to controllable valve 199 causing or allowing it to open while the displacer piston 23 is in proximity causing sensors 180 and 182 to be in magnetic proximity. When controllable valve 199 is in the open position, the working fluid is allowed to flow freely through passageway 195 to the cold space via cold port 97.

As is common in the art, once the cold space acts thermodynamically on the working fluid, power piston 22, and displacer piston 23, the cooled working fluid returns via cold port 97 through passageway 195 and through the open valve 199 into the hot space to end the cycle and begin the cycle subsequently. In timed fashion, the displacer piston 23 moves inwardly and moves sensor 180 out of close proximity with sensor 182 causing a mechanical or electromechanical signal to cause controllable valve 199 to close after a substantial amount of the working fluid has passed controllable valve 199 and through port 100 into the hot space.

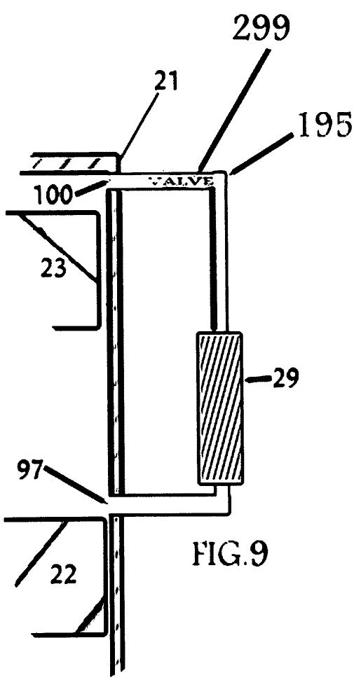

FIG. 9 is a diagrammatic sectional view of the passageway 195 showing an alternate configuration of the present invention including the passageway 195 depicting a controllable valve 299 (actual valve not shown). Valve 299 is placed within the passageway to restrict or permit the working fluid to flow in the desired direction and may be controlled by conventional means used in the art of controlling valve operation including pressure, temperature, mechanical, electromechanical or other means.

FIG. 9 also can be referenced to describe an alternative embodiment to the present invention described in FIG. 6 which depicts a simplified passageway 195. For purposes of illustrating the present alternative embodiment of the present invention, FIG. 9 now describes valve 299 as a two-way controllable valve. The working fluid is heated and cooled in similar fashion depicted in FIGS. 1 through 6 above. In FIG. 9, the working fluid is held in the hot space by valve 299 until it reaches a certain pressure or temperature. The pressure or temperature has the effect of opening the valve 299 allowing the heated working fluid to exit through port 100 into the passageway 195 towards the cold space as similarly described in FIG. 2, where it is cooled and can return through cold port 97 into passageway 195 flowing through valve 299 and into the hot space via port 100, whereby pressure or temperature means close the valve to begin a new cycle. Valve 299 may be controlled by timed release, mechanical control, electromechanical control, pressure, or other similar means having the same effect of retaining the working fluid in the hot space, controlling its release into the passageway for movement into the cold space and controlling its movement back into the hot space.

Each of these methods serves to limit flow of the working fluid during the heating operation of the Stirling cycle and allow flow of the working fluid after the cooling operation of the cycle. As in FIGS. 1 through 9 above, the improvement the present invention provides is to contain the working fluid in the hot space for a relatively longer period of time, when compared to the present art, in order to further heat the working fluid increasing its thermodynamic force in the cycle.

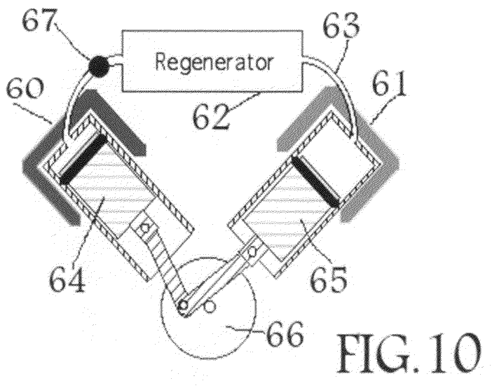

FIG. 10 is a diagrammatic sectional view of an alternative type of external combustion engine, or kinematic Stirling engine. This alternative view depicts an alternative embodiment of the present invention showing the hot end 60 and the cold end 61 being connected by the passageway 63, shown with optional regenerator 62. The working fluid moves through the passageway 63 via valve 67 that is closed when the working fluid is heating up in the beginning of its cycle in the hot space. As the working fluid becomes heated, it begins to expand moving the displacer piston 64 outward towards the flywheel 66. Once the pressure in the hot work space has attained the desired level, the valve then opens to allow the working fluid to flow through the valve and thus through the passageway to be cooled in or near the cold space where it acts upon power piston 65 and is returned through the open valve 67 and into the hot space where the cycle begins again. In this configuration, the controllable valve may be place anywhere within passageway 63 to restrict or allow flow as desired.

From the embodiments of FIGS. 1 through 10 above, the valves may be controlled by mechanical, electromechanical, pressure, temporal, or temperature means. The check valves or their equivalents may be controlled so that the frequency of opening and closing can serve to have the additional effect of improving the operation of the machine by providing a means of regulation of the frequency of operation.

From the above embodiments of FIGS. 1 through 10 it is evidenced that a number of passageway configurations for interconnecting the hot space and cold space are possible without departing from the inventive concept of the present invention which comprises a means of permitting the working fluid to remain in the hot space longer than in the absence of those means, thereby creating more thermodynamic work on the displacer piston in the outward stroke direction of the Stirling cycle. Also, from the above embodiments of FIGS. 1 through 10 it is evidenced that a number of flow restriction means, referred to as valves in the FIGS. 1 through 10, for controlling flow of the working fluid between the hot space and cold space are possible without departing from the inventive concept of the present invention which comprises a means of permitting the working fluid to remain in the hot space longer than in the absence of those means, thereby creating more thermodynamic work on the displacer piston in the outward stroke direction of the Stirling cycle, to flow to the cold space and to return to the hot space to the beginning of the cycle.

The present invention is not intended to be limited by the specific embodiments described herein as there are other flow controlling designs which may be adapted without departing from the inventive concept disclosed herein. Although the present invention has been described as adapted to free piston Stirling engines, it is equally applicable to other Stirling machines used as heat pumps and refrigerators and to other free piston machines as would be understood by one of ordinary skill in the art.

While the present free piston Stirling machine has been described above in terms of a machine having a piston and a displacer which reciprocate within the same housing structure 21, it is well known that there are numerous other possible alternative yet equivalent configurations as evidenced by a number of treatises and texts on the subject (cf. Stirling Engines, by G. Walker, Oxford University Press, 1980). For example, it is well known in the art that the piston and displacer may be housed in two substantially different cylinders which are fluidally interconnected. The present invention contemplates any of these well known alternative yet equivalent configurations.

While certain preferred embodiments of the present invention have been disclosed in detail, it is to be understood that various modifications may be adopted without departing from the spirit of the invention or scope of the claims included herein.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1) An improved Stirling cycle engine having a housing including at least one cylinder and at least one piston sealingly reciprocatable in the cylinder, the housing enclosing at least one work space bounded by a first end of the piston and also enclosing at least one second space bounded by the opposite end of the piston, both spaces containing a working gas that moves from one of the spaces to the other through at least one passageway, wherein the improvement comprises the combination of:
a passageway in communication between the hot work space and the cold space and having a means that limits flow of working fluid from the hot space to the cold space or from the cold space to the hot space; and
a means that allows the working fluid to remain in one space relatively longer than if no such means were employed.

2) An improved Stirling cycle engine having a housing enclosing at least one work space bounded by the piston and another work space bounded by a separate piston, both spaces containing a working gas that moves from one of the spaces to the other through a passageway, wherein the improvement comprises the combination of:
a passageway in communication between the hot work space and the cold space and having a means that limits flow of working fluid from the hot space to the cold space or from the cold space to the hot space; and
a means that allows the working fluid to remain in one working space relatively longer than if no such means were employed.

3. A flow restricting apparatus in accordance with claim 1 or claim 2 that contains the working fluid in the work space.

4. In accordance with claim 1 or claim 2, an apparatus that contains the working fluid by utilizing a piston to block a port that would otherwise open and allow the working fluid to become uncontained from the cold work space or hot work space.

5. In accordance with claim 1 or claim 2, a flow controlling apparatus that can be used to limit or control working fluid entering the work space.

6. In accordance with claim 1 or claim 2, a flow controlling apparatus that can be used to limit or control working fluid exiting the work space.

7. In accordance with claim 1, claim 2, and claim 3 a means of controlling flow restriction devices by mechanically activating means.

8. In accordance with claim 1, claim 2, and claim 3, a means of controlling flow restriction devices by activating means that are sensitive to temperature.

9. In accordance with claim 1, claim 2, and claim 3, a means of controlling flow restriction devices by activating means that are sensitive to pressure.

10. In accordance with claim 1, claim 2, and claim 3, a means of controlling flow restriction devices by activating means that are magnetic.

11. In accordance with claim 1, claim 2, and claim 3, a means of controlling flow restriction devices by activating means that are electrical.

12. In accordance with claim 1, claim 2, and claim 3 the flow controlling means oriented to permit the controlled passage of working fluid between the spaces in a manner that improves beneficially the performance of the thermodynamic principles employed in Stirling engines or to prevent passage of the working fluid in a manner detrimental to the thermodynamic principles employed in Stirling engines.
